(19) United States
(12) Patent Application Publication
(10) Pub. No.: US 2012/0271458 A1
(43) Pub. Date: Oct. 25, 2012

(54) METHOD OF MODIFYING EXCITATION RESPONSE CHARACTERISTICS OF A SYSTEM

(75) Inventors: Alison J. MCMILLAN, Uttoxeter (GB); Richard P G COGHLAN, Derby (GB)

(73) Assignee: ROLLS-ROYCE PLC, London (GB)

(21) Appl. No.: 13/444,453

(22) Filed: Apr. 11, 2012

(30) Foreign Application Priority Data
Apr. 19, 2011 (GB) 1106547.1

(51) Int. Cl. G05B 15/02

(52) U.S. Cl. 700/275

(57) ABSTRACT

A method of modifying excitation response characteristics of a structural system, including an aerofoil blade mounted to a support disc, including the steps: (a) identifying a limit cycle associated with the system; (b) determining the amplitude of the limit cycle; (c) comparing the amplitude of the limit cycle against a threshold value; and (d) if the amplitude of the limit cycle is greater than a threshold value, modifying the system to reduce the amplitude of the limit cycle.

This invention relates to a method of modifying excitation response characteristics of a system, and particularly, but not exclusively, concerns a method of modifying excitation response characteristics of an aerofoil blade in a turbine engine.

Vibration testing and analysis methods are a well known area in the development of gas turbine engines and their components. For example, vibration testing and analysis is often conducted to identify modal frequencies of aerofoil blades mounted within the flow path of an engine. The modal frequencies are then compared against possible excitation frequencies at which the aerofoil blade is expected to be excited during operation, for example as a consequence of unsteady flow caused by upstream structures. If the excitation frequencies coincide with the modal frequencies of the aerofoil blade, the structure of the aerofoil blade can be modified to shift the modal frequency or frequencies away from the excitation frequencies. This process ensures that, when in use, aerofoil blades are not excited at their modal frequencies for prolonged periods of time or at critical engine speeds that result in high amplitude vibrations which increase fatigue of the aerofoil blade.

However, it is not always possible to modify the structure of an aerofoil blade to change modal frequencies without adversely affecting other parameters, such as aerodynamic characteristics or the strength of the aerofoil blade. Consequently, in order to prevent high amplitude vibrations at modal frequencies it is often necessary to provide damping, which can be complex and costly.

Furthermore, it is difficult to predict accurately the modal frequencies of the aerofoil blade. These frequencies can vary for a number of reasons; for example, variations in geometric tolerances or materials from blade to blade; or variations with time in the operating conditions (temperature, applied loads, etc.) of a particular blade. Some measure of uncertainty is therefore introduced during analysis so that the modal frequency is indicated as a range of possible frequencies. This uncertainty means that ranges of neighbouring modal frequencies can sometimes overlap. Consequently, there can be a broad range of frequencies within which at least one modal frequency is known to exist. This makes avoidance of modal frequencies during operation of the engine difficult and often impracticable.

There therefore exists a need to reduce the impact that excitation at a modal frequency has on the aerofoil blade.

According to a first aspect of the present invention there is provided a method of modifying excitation response characteristics of a structural system comprising the steps:
(a) identifying a limit cycle associated with the system;
(b) determining the amplitude of the limit cycle;
(c) comparing the amplitude of the limit cycle against a threshold value; and
(d) if the amplitude of the limit cycle is greater than a threshold value, modifying the system to reduce the amplitude of the limit cycle.

Steps (b) to (d) may be repeated until the amplitude of the limit cycle is not greater than the threshold value.

Step (a) may comprise the step of first modifying the system to create a limit cycle associated with the system.

The limit cycle may be generated by non-linear vibration of the system. The non- linear vibration may be characterised by variation in mode shape of the system and/or by variation in modal frequency of the system.

The mode shape and/or modal frequency of the system may vary with deflection of the system. It will be appreciated that either one or both of the mode shape and modal frequency of the system may vary with deflection together and that variation of one may influence variation of the other.

The system may be characterised by a non-linear elastic response to excitation, which may be caused by variation in the stiffness of the system in response to excitation of the system. Variation in the stiffness may be caused by localised temperature fluctuations in the system.

The system may comprise a plurality of bodies having indeterminate contact conditions between at least two of the bodies, the mode shape and/or modal frequency of the system being variable with change in the contact conditions. It will be appreciated that either one or both of the mode shape and modal frequency of the system may vary with change in the contact conditions and that variation of one may influence variation of the other.

The system may be modified in step (d) by varying the material properties of the system and/or by varying the geometry of the system.

The method may further comprise the steps of:
(e) identifying a characteristic frequency associated with the system;
(f) determining whether the characteristic frequency is bounded by the limit cycle; and
(g) if the characteristic frequency is not bounded by the limit cycle, modifying the system to vary the limit cycle.

Steps (f) and (g) may be repeated until the limit cycle bounds the characteristic frequency.

The characteristic frequency may be a modal frequency associated with the system.

The system may comprise an aerofoil blade mounted to a disc.

According to a second aspect of the present invention there is provided a process for designing a component for a system, the process including a method in accordance with the first aspect of the invention.

According to a third aspect of the present invention there is provided a structural system configured to have a limit cycle having an amplitude which is not greater than a predetermined threshold value. The system may exhibit a non-linear vibrational response which generates the limit cycle.

For a better understanding of the present invention, and to show more clearly how it may be carried into effect, reference will now be made, by way of example, to the accompanying drawings, in which:-

FIG. 1 is a schematic representation of an aerofoil blade mounted in a slot;

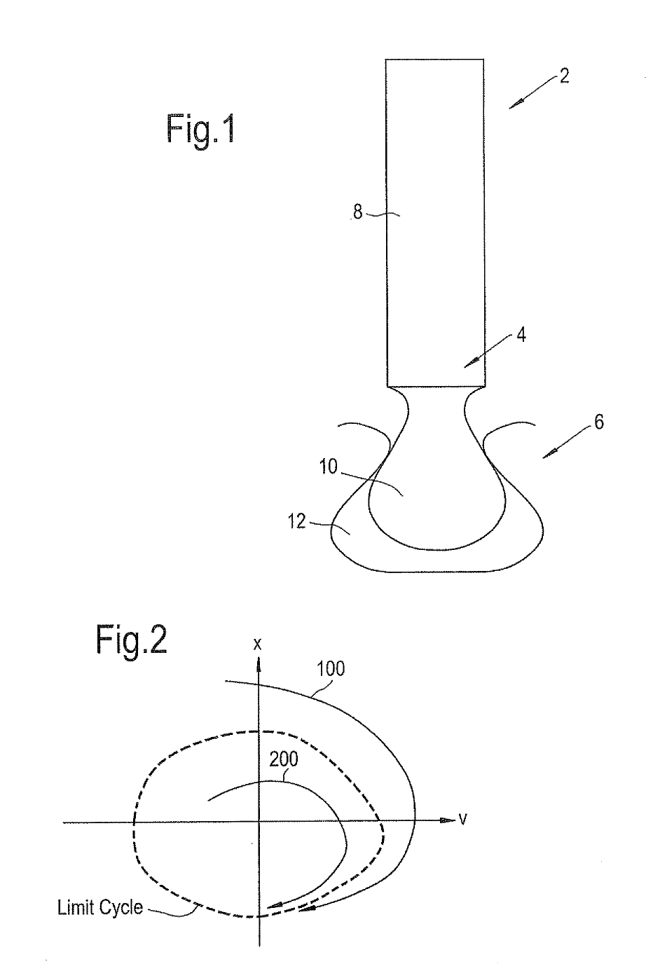

FIG. 2 is a graphical representation of a response characteristic of a system;

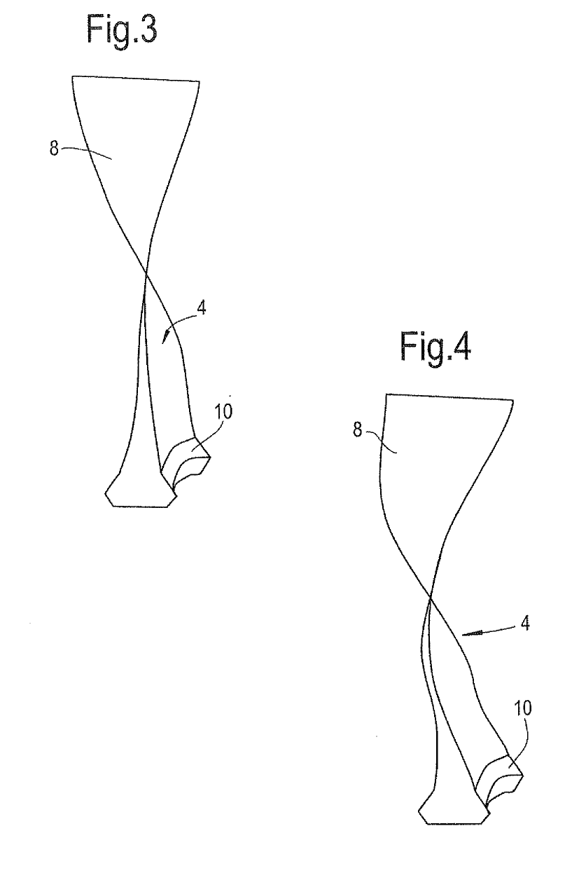

FIG. 3 is a schematic representation of an aerofoil blade;

FIG. 4 is a schematic representation of the aerofoil blade shown in FIG. 3 in a deflected condition;

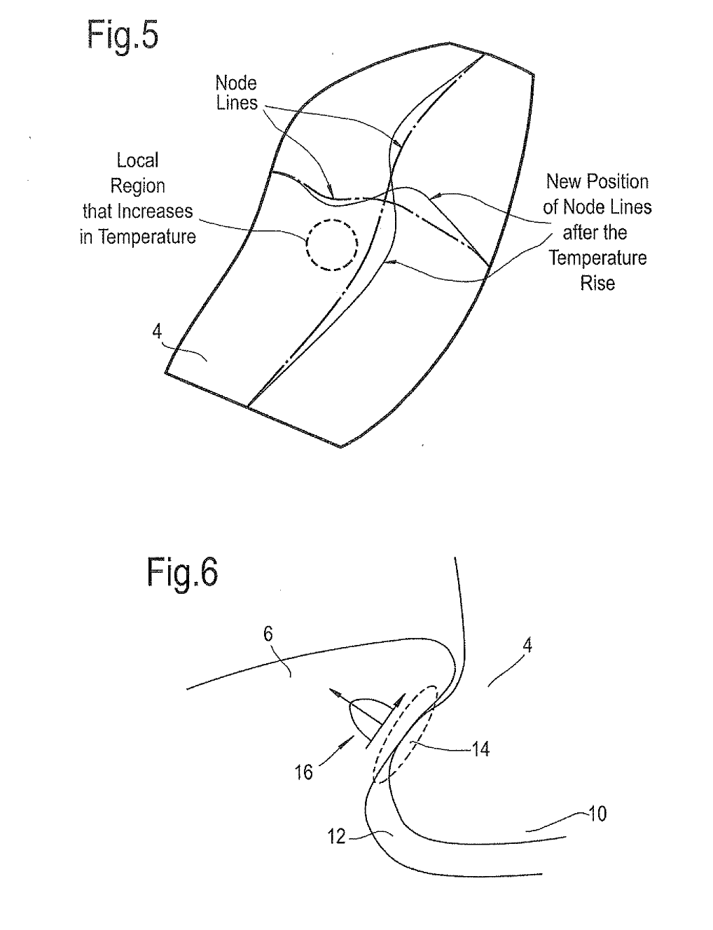

FIG. 5 is a partial schematic representation of an aerofoil blade; and

FIG. 6 is an enlarged partial sectional view of the arrangement shown in FIG. 1.

General Disclosure

A method of modifying excitation response characteristics of a system to address the problems described above is set out below.

FIG. 1 shows a structural system 2 comprising an aerofoil blade 4 mounted to a support disc 6 (shown in part). The aerofoil blade 4 comprises an aerofoil portion 8 integrally supported by a root 10. The root 10 is mounted within a slot 12 on the disc 6.

The system 2 is modelled using computational numerical techniques such as a finite element analysis in conjunction with non-linear time-domain or frequency-domain vibration analysis tools. The model is then analysed to determine whether the system 2 exhibits a non-linear vibrational response to excitation. Non-linear vibration is characterised by variation in a modal frequency and/or a mode shape of the system as the system vibrates. Thus, a non-linear response is deemed to exist when modal frequencies and/or mode shapes of a system vary as the system is excited. This may result from changes in the system throughout each oscillation, for example, changes in the geometry of the structural system at large amplitudes of displacement or deflection which contribute to a modal frequency or mode shape of the structural system at that high amplitude or deflection. Alternatively, progressive changes in the system during vibration, for example softening of the structural system as a result of localised heating caused by flexing of the structural system may also produce a change in the modal frequency and/or mode shape of the system.

In order to model a system which exhibits a non-linear vibrational response, the elastic properties of the system must be modelled in combination with the energy sources (e.g. excitation means) and sinks (e.g. stiffness variation, boundary condition variation) which act on the system. The analysis thus differs from conventional modelling techniques which generally assume a linear vibrational response of a system. A non-linear analysis is able to account for variation in the modal frequencies and mode shapes as the system is excited.

A non-linear response may, for example be caused by large deflection (e.g. of the aerofoil blade 4), non-linear elasticity of the system 2 or indeterminate contact conditions (e.g. between the root 10 and the slot 12). Each of these specific mechanisms is described below.

If the system 2 exhibits a non-linear vibrational response, it is determined whether the response is periodic. if the response is periodic, then it is further determined whether the response exhibits a limit cycle. Since a limit cycle is by definition periodic, the step of first determining whether the response is periodic may be integral with the step of identifying a limit cycle. A limit cycle will exist where, for various different initial conditions, motion of the aerofoil blade 4 converges on the same periodic motion. An example of a limit cycle is shown in FIG. 2. The limit cycle is represented by a dashed line in the velocity (horizontal axis) and displacement (vertical axis) domain. The amplitude of the limit cycle corresponds to the maximum displacement which in the example shown in FIG. 2 is at the intersection with the vertical axis. Two separate curves 100, 200 represent the displacement and velocity of the system 2 as it converges on the limit cycle from different initial conditions. The first curve 100 has an initial displacement which is greater than the amplitude of the limit cycle. The second curve has an initial displacement which is less than the amplitude of the limit cycle. In each case the system 2 tends towards motion on the limit cycle.

If a limit cycle exists, the amplitude of the limit cycle is ascertained. The amplitude of the limit cycle is then compared against a threshold value. The threshold value is a maximum amplitude at which the system 2 can vibrate over long periods or at specific frequencies (e.g. frequencies associated with particular engine speeds within which the aerofoil blade is mounted) without causing fatigue which would compromise operational life of the system 2.

The system 2 is then modified to reduce the amplitude of the limit cycle and re- evaluated. The system 2 may be modified by changing a property of the system 2 such as the geometry, material or construction of the aerofoil blade or the contact properties between the root 10 and the slot 12. The process is an iterative process for which numerous optimisation techniques can be employed. Examples of such optimisation techniques include: genetic algorithms, simulated annealing and ant-colonisation models. These can be augmented with techniques such as Kriging or response surface methodology to improve the efficiency of the optimisation process.

If a limit cycle does not exist, properties of the system 2, for example the geometry (internal and external) of the aerofoil blade 4, material distribution or fixation points can be modified to introduce a limit cycle.

### Large Deflection Non-Linearity

FIG. 3 shows an aerofoil blade 4 in a nominal position. The aerofoil blade 4 is secured at its root 10 to a disc 6, although this .is not shown. The aerofoil blade 4 effectively acts as a slender body cantilevered at its root 10. FIG. 4 shows the same aerofoil blade 4 deflected under load as a consequence of excitation. The aerofoil blade 4 is shown at a maximum amplitude of deflection.

As the aerofoil blade 4 is excited at a modal frequency, the amplitude of the vibrations increases as more energy is transferred into the aerofoil blade 4. As the aerofoil blade 4 deflects during each oscillation, the bending of the aerofoil blade 4 causes variation of the modal frequencies and/or mode shapes of the aerofoil. The vibration response of the aerofoil blade 4 is therefore non-linear. The aerofoil blade 4 is not, however, stressed beyond its elastic limit. It is the change in geometry caused by the deflection of the aerofoil blade 4 which alters the modal frequency and the mode shape. The change is therefore most pronounced at large amplitudes of deflection. The modal frequency may, for example, decrease the more the aerofoil blade 4 deflects. As a consequence, the modal frequency of the aerofoil blade 4 shifts away from the frequency of excitation making it less responsive to the excitation frequency. The aerofoil blade 4 will therefore reach an amplitude at which the modal frequency is sufficiently different from the excitation frequency so that continued excitation at the excitation frequency does not cause any further increase in the amplitude of vibration.

Conversely, if the amplitude of vibration begins to decrease, the modal frequency of the aerofoil blade 4 shifts back towards the excitation frequency resulting in increased excitation and hence a renewed increase in the amplitude of vibration. Consequently, the amplitude of vibration neither increases nor decreases substantially. The aerofoil blade 4 is therefore trapped in a limit cycle in which the amplitude of vibration is substantially constant. This condition is maintained while the aerofoil blade 4 is excited at that particular excitation frequency. The maximum amplitude of vibration is therefore constrained by the limit cycle. The limit cycle is periodic and exhibits a frequency.

Once the limit cycle has been identified, the amplitude can be compared against a threshold value. The threshold value can be a predetermined value for which it is known that vibrations having an amplitude not more than the threshold value will not have a detrimental impact, or at least will have an acceptable impact, on fatigue life of the aerofoil blade 4 or other components of the system 2.

If the amplitude of the limit cycle exceeds the threshold value, the system 2 is modified. The system 2 may, for example, be modified by altering the interior or exterior geometry, stiffness, material distribution or composition of the aerofoil blade 4, The system 2 is modified with an intent to reduce the amplitude of the limit cycle.

The system 2 is then re-analysed to determine the amplitude of the limit cycle. The steps of modification and analysis are repeated until the amplitude of the limit cycle is below the threshold value. The modification and analysis process is an iterative process.

In some circumstances, the system 2 may not exhibit a limit cycle, or may exhibit a limit cycle which is not suitable for adaptation by modification of the system 2. In these circumstances the system 2 can be modified as described above with the intention of introducing a limit cycle into the system 2. In other circumstances, some anticipated initial conditions may not necessarily lead to motion attracted to the limit cycle. The system 2 is therefore modified, as described above, to ensure that all initial conditions which are to be constrained by the limit cycle lead to the limit cycle.

The amplitude of the limit cycle may be zero, in which case there is no motion and the system 2 tends towards a stationary state.

It will be appreciated that where an aerofoil blade 4 is curved, the mode shapes may be more sensitive to deflection of the aerofoil blade 4. The amount of curvature of the aerofoil blade 4 can therefore be a parameter which is modified to reduce the amplitude of the limit cycle.

### Non-Linear Elasticity

FIG. 5 is a schematic representation of a portion of an aerofoil blade 4 in the vicinity of intersecting node lines (i.e. a node). The aerofoil blade 4 is made of a composite material having a low thermal conductivity and a stiffness which varies with temperature. The composite may be an organic matrix composite, for example a carbon fibre reinforced polymer.

As the aerofoil blade 4 is excited by an excitation means it vibrates in one or more modes. The fluctuation in the shape of the aerofoil blade 4 during each oscillation creates stresses and strains within the aerofoil blade 4. This is particularly severe at highly stressed or strained regions of the aerofoil blade 4. The stresses and strains work the composite material and so, due to the visco-elastic properties of the material, generate localised heating of the aerofoil blade 4. The heating increases the temperature of the composite material which causes localised softening, particularly at the stress/strain maxima which have the highest stress/strain reversal. This localised softening is enhanced by the low thermal conductivity of the composite material which inhibits heat dissipation to surrounding areas. The localised softening reduces the stiffness of the composite material in the vicinity of the stress/strain maxima thereby reducing the modal frequency and changing the mode shape of the aerofoil blade 4. The reduction in the modal frequency for a composite aerofoil blade may exceed 5% under test conditions where forcing can be frequency matched.

Changes of the modal frequencies result in an effect which is similar to that described with respect to large deflections: the modal frequency shifts away from the excitation frequency and so the aerofoil blade 4 becomes less responsive at the excitation frequency. If the amplitude of vibration reduces, the temperature falls and the aerofoil blade 4 begins to harden so that it is again excited by the excitation means, increasing the temperature and again softening the aerofoil blade 4 at the stress/strain maxima. The temperature, and hence stiffness, at the stress/strain maxima thus becomes quasi-static at the frequency at which the excitation does not increase the amplitude further, but from which the amplitude does not decrease. The aerofoil blade 4 is therefore trapped in a limit cycle oscillation in which the amplitude of vibration is substantially constant.

Once the amplitude of the limit cycle has been ascertained, it is compared against a threshold value. If the amplitude is greater than the threshold value, the aerofoil blade 4 is modified. The aerofoil blade 4 can, for example, be modified by changing the thermal conductivity, lay-up or geometry of the aerofoil blade 4.

The changes in mode shape alter the way in which the aerofoil blade 4 interacts with the surrounding airflow. Changes in mode shape can be particularly advantageous in controlling amplitude of vibration where excitation at the modal frequency is caused by an aero-elastic coupling between the aerofoil blade 4 and the surrounding airflow; a phenomenon of forced-response vibration or self-excited vibration, the latter commonly referred to as flutter. The changes in the mode shape caused by the localised softening change the aerodynamic profile of the aerofoil portion 8 of the blade 4 and so alter the interaction between the airflow and the aerofoil portion 8. In particular, changes in the mode shape alter the phase of unsteady lift over the blade which limits the energy input per vibration cycle. Limitation of the energy input inhibits further excitation of the aerofoil blade 4 thereby disrupting the aero-elastic coupling between the aerofoil blade 4 and the surrounding airflow.

A reduction in the amplitude causes a tendency to revert to the original, low-amplitude mode shape of the aerofoil blade 4. As the mode shape changes back to the original mode shape the aerofoil blade 4 is again excited by the airflow, leading to softening of the aerofoil blade 4 at the stress/strain maxima. Consequently, the aerofoil blade 4 becomes trapped in a limit cycle oscillation in which the amplitude of vibration is substantially constant.

Once the amplitude of the limit cycle has been ascertained, it is compared against a threshold value. If the amplitude is greater than the threshold value, the aerofoil blade 4 is modified as described above.

Changes in a mode shape with amplitude are most pronounced as the modal frequency of the aerofoil blade 4 reduces to approach a lower modal frequency of the aerofoil blade 4.

It will be appreciated that mechanisms other than localised softening may be implemented to vary the mode shape. For example, materials having switchable stiffness, such as shape memory alloy, or which exhibit significant changes in stiffness as a function of temperature can be incorporated into the aerofoil blade 4.

Although organic matrix composites, such as carbon fibre reinforced polymers, are particularly suitable owing to the fact that vibration causes temperature changes which generate a change in the stiffness of the composite, other suitable composites may be used, including metallic composites comprising multiple alloys having different properties. An aerofoil blade made of a single material and having a hollow cavity may also be regarded as a suitable composite.

Fibres having a thermal conductivity which differs from that of the surrounding aerofoil blade material may be incorporated into the aerofoil blade to increase or decrease thermal conductivity. This would be advantageous for controlling mode shape changes or for maintaining temperature stability. Other types of fibres which could be used include glass fibres or aramids (such as those marketed under the registered trade marks KEVLAR and DYNEEMA), which have high strength and are resistant to high temperatures. Tailored use of fibres in order to increase the non-linear response or manage the amplitude of vibration can be used to modify the aerofoil blade.

The visco-elastic behaviour of the resin used in a composite material could be varied to modify the aerofoil blade, for example by selecting different resins for the whole aerofoil blade or parts of the aerofoil blade.

### Indeterminate Boundary Conditions

FIG. 6 is a schematic representation of part of the blade root 10 mounted within the slot 12 of the disc 6. There is an area of contact 14 between an upper surface of the root 10 and inward surface of the slot 12. As the aerofoil blade 4 is excited, normal and tangential forces 16 are exerted between the root 10 and the slot 12. These forces cause the root 10 to slip with respect to the slot 12. The root 10 can be arranged to slip across part or all of the width of the contact area 14. The aerofoil blade 4 therefore exhibits indeterminate contact conditions which give rise to non-linear vibration of the aerofoil blade 4. In particular, slippage or partial slippage of the root 10 with respect to the slot 12 causes a variation in the mode shape of the aerofoil blade 4.

The variation in mode shape changes the way in which the aerofoil blade 4 interacts with the driving excitation so as to inhibit further excitation of the aerofoil blade 4. For example, the change in mode shape interrupts aero-elastic coupling (e.g. flutter) between the aerofoil blade 4 and the surrounding airflow. The aerofoil blade 4 is therefore trapped in a limit cycle in which the amplitude of the limit cycle is substantially constant. The amplitude of the limit cycle is then ascertained. If the amplitude of the limit cycle is greater than a threshold value, contact conditions, such as contact area, contact angle or coefficient of friction between the root 10 and slot 12 are modified with the intention of reducing the amplitude of the limit cycle. The process of determining the amplitude of the limit cycle and modifying the contact conditions between the root 10 and the slot 12 is repeated until the amplitude of the limit cycle is determined to be below the threshold value.

In a variant, an array of aerofoil blades is mounted to a disc for rotation. Each aerofoil blade is modified to exhibit a limit cycle which differs from other blades. The non-linear response of these blades thus differs from blade to blade. This ensures that flutter mechanisms which rely on aerofoil blade symmetry are disrupted.

For each of the methods described above the aerofoil blade may be made of a composite or a single material.

It will be appreciated that the invention can be applied to other systems comprising isolated or coupled components; for example fan, compressor or turbine blades and engines comprising such components. Furthermore, the invention could also be applied to systems such as wind/water turbines, hydrofoils, suspension systems (e.g. vehicle suspension systems), earthquake resistant buildings and bridges, in particular bridges subject to high vehicle inertial loads and/or wind loading.

It will be appreciated that the methods described above would be suitable for limiting vibration response of a system to other means of excitation including engine order coupling (e.g. shaft whirl).

It will be appreciated that a limit cycle of a system may vary with a change in operation parameters, for example as a consequence of changes in the temperature of the whole aerofoil blade or because of centripetal stiffening.

1. A method of modifying excitation response characteristics of a structural system comprising the steps:
identifying a limit cycle associated with the system;
determining the amplitude of the limit cycle;
comparing the amplitude of the limit cycle against a threshold value; and
if the amplitude of the limit cycle is greater than a threshold value, modifying the system to reduce the amplitude of the limit cycle.

2. A method as claimed in claim 1, wherein steps (b) to (d) are repeated until the amplitude of the limit cycle is not greater than the threshold value,

3. A method as claimed in claim 1, wherein step (a) comprises the step of first modifying the system to create a limit cycle associated with the system.

4. A method as claimed in claim 1, wherein the limit cycle is generated by non-linear vibration of the system.

5. A method as claimed in claim 4, wherein the non-linear vibration comprises variation in mode shape of the system.

6. A method as claimed in claim 4, wherein the non-linear comprises variation in modal frequency of the system.

7. A method as claimed in claim 5, wherein the system comprises a non-linear elastic response to excitation.

8. A method as claimed in claim 5, wherein the system comprises a plurality of bodies having indeterminate contact conditions between at least two of the bodies, the mode shape and/or modal frequency of the system being variable with change in the contact conditions.

9. A method as claimed in claim 1, further comprising the steps of:
identifying a characteristic frequency associated with the system;
determining whether the characteristic frequency is bounded by the limit cycle; and
if the characteristic frequency is not bounded by the limit cycle, modifying the system to vary the limit cycle.

10. A method as claimed in claim 9, wherein steps (f) and (g) are repeated until the limit cycle bounds the characteristic frequency.

11. A method as claimed in claim 9, wherein the characteristic frequency is a modal frequency associated with the system.

12. A method as claimed in claim 1, wherein the system comprises an aerofoil blade mounted to a disc.

13. A process for designing a component for a system, the process including a method as claimed in claim 1.

14. A structural system configured to have a limit cycle having an amplitude which is not greater than a predetermined threshold value.

15. A structural system as claimed in claim 14, wherein the system exhibits a non-linear vibrational response which generates the limit cycle.
